(19) United States
(12) Patent Application Publication
(10) Pub. No.: US 2005/0271187 A1
(43) Pub. Date: Dec. 8, 2005

(54) Method for representing a list containing presence data

(75) Inventors: Bernhard Bohmer, Berlin (DE); Andreas Hauptvogel, Berlin (DE); Michael Lemke, Berlin (DE); Wiebke Wiedemann, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/525,989

(22) PCT Filed: Oct. 24, 2002
(86) PCT No.: PCT/DE02/03967

§ 371 Date: Mar. 1, 2005

(30) Foreign Application Priority Data
Sep. 2, 2002 (DE) 10241098.4

(51) Int. Cl. H04M 1/64

(52) U.S. Cl. 379/67.1

(57) ABSTRACT

The invention relates to a method for representing a list (LI) containing presence data (PD) on a display unit (A) of a first communication terminal (KEG1). The presence data is stored on a presence computer (PR). Presence data from the presence computer is requested by means of a request message (ABN) by means of a list generating device (LE). The presence data concerns a predetermined selection of additional communication terminals (KEG2, KEG3) which are associated with users. Format data (FD) associated with the first communication terminal (KEG1) is determined by the list generating device which describes a data format which can be represented on the display unit of the first communication terminal. Presence data is prepared by using the format data such that a list (LI) is produced which has a data format which can be represented and the list is transmitted to the first communication terminal for displaying on the display unit.

### CLAIM FOR PRIORITY

This application is a national stage of PCT/DE2002/003967, published in the German language on Mar. 18, 2004 which claims priority to German Application No. 102 41 098.4 filed Sep. 2, 2002, which is incorporated herein, in its entirety, by reference.

### TECHNICAL FIELD OF THE INVENTION

The invention relates to a method for showing a list containing presence data on a display unit on a communication terminal.

### BACKGROUND OF THE INVENTION

The document 3GPP TS 23.141 V0.0.0. “3rd Generation Partnership Project; Technical Specification Group Services and System Aspects; Presence Service; Architecture and Functional Description (Release 6)” dated June 2002 discloses a service which is referred to as a “presence service” in which a presence computer (presence server) is used to monitor characteristics of selected communication subscribers. Such characteristics include, by way of example, the respective current accessibility by telephone, by the short message service (SMS) or by e-mail. Information about such characteristics is gathered and is transferred in the form of presence data to communication terminals which require such presence data.

### SUMMARY OF THE INVENTION

The invention discloses a method which can be used in a versatile manner for showing presence data using communication terminals.

In one embodiment of the invention, there is a method for showing a list containing presence data on a display unit on a first communication terminal, where the presence data are held on a presence computer, in which a list generation device uses a retrieval message to retrieve presence data from the presence computer, the presence data relating to a predetermined selection of further communication terminals which are associated with users, the list generation device ascertains format data which are associated with the first communication terminal and which describe a data format which can be shown on the display unit of the first communication terminal, the format data are used to condition the presence data such that a list is produced which has the displayable data format, and the list is transferred to the first communication terminal for display on the display unit. In this context, the presence data may advantageously be displayed on display units belonging to very different communication terminals. Such first communication terminals may, by way of example, be in the form of mobile telephones of various types (e.g. mobile telephones which operate on the basis of the GSM, GPRS or UMTS standard), mobile computers with a mobile radio interface, palmtops or personal computers. The conditioning or formatting of the presence data which is to be performed using the format data advantageously generates a list which matches the respective first communication terminal used and which can be shown on the display unit of the respective communication terminal. This allows the presence data to be used across devices and communication systems through the use of very different communication terminals.

In this case, the invention may proceed in a manner such that
the format data are ascertained by virtue of the list generation device receiving a type information item from the first communication terminal, and
the type information item is used by the list generation device to read the format data from a data store.

In this context, it is advantageously not necessary to transfer all of the (e.g. extensive) format data, but rather just the type information item (which is not complex to transfer, for example) from the first communication terminal to the list generation device.

In another embodiment of the invention, the list generation device retrieves from the presence computer, as presence data, data which describe an opportunity for communication between the first communication terminal and the further communication terminals at the time of retrieval. The effect advantageously achieved by the use of such presence data is that a user of the first communication terminal is informed about the opportunities for communication with the further communication terminals which exist at the time of retrieval.

In still another embodiment of the invention, the list is generated using list structure data, describing the structure of the list, which have already been transmitted from the first communication terminal to the list generation device. These list structure data advantageously allow the first communication terminal to stipulate the basic structure which the list to be shown needs to have and the information categories which therefore need to be shown using this list.

In the invention, in another embodiment, the list is stored in the list generation device, and if further list structure data arrive after the time of storage then the list is adapted in line with these further list structure data. This means that a crude list which has already been created is preferably matched to a current requirement of the first communication terminal without the need for the list generation device to retrieve all of the presence data from the presence server again.

In yet another embodiment of the invention, the list generation device receives a selection message which is transferred from the first communication terminal and which contains information about the predetermined selection of further communication terminals. This means that the first communication terminal may advantageously stipulate those further communication terminals about which it is necessary to ascertain presence data and to show them on the display unit of this first communication terminal.

The invention may also be embodied such that the list generation device uses the retrieval message to transfer the information about the predetermined selection of further communication terminals to the presence computer, which then ascertains the presence data about these further communication terminals and transfers them to the list generation device.

The inventive method may proceed in a manner such that the presence computer ascertains the presence data by reading from a memory apparatus.

The invention may also proceed in a manner such that the list generation device creates charging data which relate to the list which has been transferred to the first communication terminal. These charging data may advantageously be used to invoice the first communication terminal for the involvement arising in the method, and a user of the first communication terminal can be charged costs which result from this involvement.

The invention may also be in a form such that the list generation device transmits the charging data to a first switching center in the first communication network, and this switching center then generates charge tickets associated with the charging data for the purpose of further processing in a charge credit device. This refined form advantageously allows the use of charge credit devices (“postprocessing billing centers, clearing houses”) which frequently exist in telecommunication networks for the purpose of charging the communication terminal user.

The invention may also proceed in a manner such that the list generation device sends the charging data to a service switching point in the first communication network, and the charging data are then taken as a basis for debiting a charge sum from a prepaid account which is associated with the first communication terminal. This refined form of the inventive method advantageously allows “prepaid billing” to be carried out using the prepaid account. Such prepaid accounts are often present in communication networks which are in the form of intelligent networks.

The invention may be perfomred such that the presence data are shown on the display unit in the form of images associated with the presence data, and activation of an image starts a communication program on the first communication terminal which allows communication between the first communication terminal and one of the further communication terminals. Displaying the presence status of the object to be monitored in image form allows a user of the method to pick up the presence information very quickly, to a certain extent “at one glance”. It is also possible to show a larger number of presence information items clearly on the (generally small) display panel of the display unit of the communication terminal (e.g. of a mobile telephone). Furthermore, this type of display allows information to be shown independently of language and in internationally comprehensible fashion.

### BRIEF DESCRIPTION OF THE DRAWINGS

The invention is described in more detail below with reference to the drawings and exemplary embodiments. In the drawings,

FIG. 1 shows an exemplary embodiment of the invention.

FIG. 2 shows an exemplary embodiment of the method taking place in a list generation device.

FIG. 3 shows an exemplary embodiment of a presence data list.

### DETAILED DESCRIPTION OF THE INVENTION

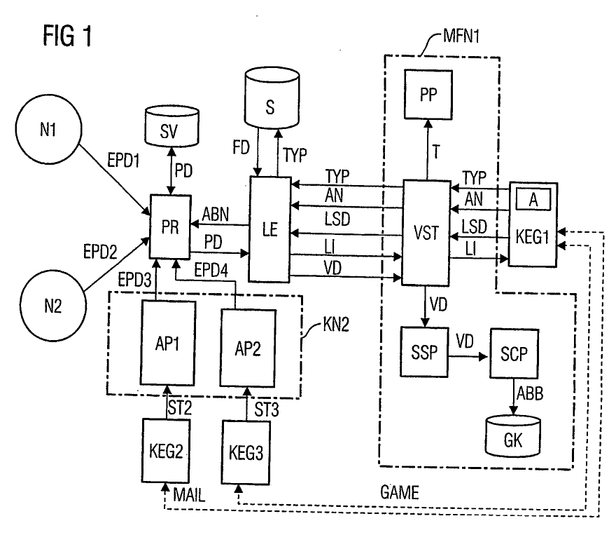

A first communication terminal KEG1 having a display unit A is shown on the right-hand side of FIG. 1. The first communication terminal KEG1 is connected to a first communication network MFN1, which has the structure of an intelligent network (IN). Accordingly, the first communication network MFN1, which is a mobile radio network, has a first switching center VST, a service switching point SSP, a service control point SCP, a prepaid charge account GK (a “prepaid account”) and a charge credit device PP (a billing center for carrying out a “postprocessing billing process”).

When the first communication terminal KEG1 requires presence data about further communication terminals (e.g. the further communication terminal KEG2 and KEG3 shown by way of example), the first communication terminal KEG1 sends a selection message AN to a list generation device LE via the switching center VST in the first communication network MFN1. The list generation device LE performs a service for showing presence data for these communication terminals which are requesting presence data. In this exemplary embodiment, the list generation device LE is arranged outside of the first communication network MFN1 and is operated independently of the first communication network MFN1. In another exemplary embodiment, however, the list generation device LE may also form part of the first communication network MFN1 or else of a second communication network KN2, the second communication network KN2 having the further communication terminals KEG2 and KEG3 associated with it in this exemplary embodiment. The first communication terminal KEG1 uses the selection message AN to notify the list generation device LE that it is requesting presence information about the further communication terminals KEG2 and KEG3. Furthermore, the first communication terminal KEG1 sends a type information item TYP to the list generation device LE; the type information item TYP contains technical features of the first communication terminal KEG1, for example the type of display unit A and the data formats which can be processed by the first communication terminal KEG1 and which can be shown on the display unit A. The first communication terminal KEG1 also sends list structure data LSD to the list generation device LE. These list structure data LSD include the information regarding what entries the list LI which is generated by the list generation device LE and is later sent to the communication terminal KEG1 needs to have in principle. BY way of example, the list structure data LSD may include the information that a list which is to be generated by the list generation device LE needs to have the following entries in the form of table columns:
a name for a user of the further communication terminal (e.g. of the further communication terminal KEG2),
a status for the user (e.g. is in a meeting),
communication options for contacting this user (for example by mobile telephone, landline telephone or e-mail),
current whereabouts of the user (and hence also the whereabouts of his mobile telephone, for example).

The respective user is the user with whom the respective further communication terminals are associated. In the case of the mobile telephone example, this is therefore the user whose SIM card (Subscriber Identity Module card) is in the mobile telephone, which means that this mobile telephone is associated with the user and is thus personalized.

The list generation device LE now uses the information from the selection message AN and the list structure data LSD to generate a retrieval message ABN which contains the information regarding what presence data the list generation device LE requires from a presence computer (presence server) PR. Presence computers PR of this type, as such, are known and are described in the document cited at the outset, for example. The presence computer PR monitors people or their communication terminals (in the example the further communication terminals KEG2 and KEG3) and collects individual presence data EPD1, EPD2, EPD3 and EPD4 about these further communication terminals. The presence computer PR is connected to the first communication network MFN1 via the list generation device LE and holds a large volume of the information available to it from the individual presence data as presence data. These presence data are stored in a memory apparatus SV which is connected to the presence computer PR. However, the memory apparatus SV may also be part of the presence computer.

In this exemplary embodiment, the individual presence data EPD1 come from a second generation mobile radio network N1 (that is to say from a mobile radio network operating on the basis of the GSM standard, for example). Such individual presence data may contain, by way of example, information about what further communication terminals—not shown in the figure—are currently registered (logged on) in the mobile radio network N1 or to what further communication terminals it is currently possible to set up mobile radio links via the network N1. The individual presence data EPD2 come from a third generation mobile radio network N2, that is to say, by way of example, from a mobile radio network operating on the basis of the UMTS (Universal Mobile Telecommunications System) standard or on the basis of the GPRS (General Packet Radio Service) standard. The individual presence data EPD2 may comprise the information regarding what further communication terminals can currently be reached by the mobile radio network N2, for example.

The further communication terminals KEG2 and KEG3 are connected to the second communication network KN2, from which a first service computer AP1 and a second service computer AP2 are shown merely schematically. In this exemplary computer, the first service computer AP1 runs an e-mail service (i.e. an application, a computer program which allows the communication terminal KEG2 to send and receive e-mail messages). As soon as the communication terminal KEG2 is used to start ST2 this e-mail application on the first service computer AP1 (i.e. as soon as the communication terminal KEG2 can be reached by e-mail), this information is transferred to the presence computer PR as individual presence data item EPD3.

In this exemplary embodiment, the further communication terminal KEG3 starts (ST3) an online game application (e.g. a computer program which allows various communication terminals to play on line via the communication network KN2) on the second service computer AP2. Since, from the time at which the program is started, the further communication terminal KEG3 can be reached via the online game and a communication link can be set up to the communication terminal KEG3 via the online computer game, an information item about the start ST3 of the game program is transferred from the second communication network KN2 to the presence computer PR as individual presence data item EPD4.

If the presence computer PR iuncludes the individual presence data which have been retrieved by the list generation device LE in the form of the presence data, then the presence computer PR transfers these retrieved presence data PD to the list generation device LE without delay. If not all of the retrieved presence data PD are available on the presence computer PR, however, then the presence computer PR ascertains the necessary individual presence data by requesting them from the networks N1 or N2 or from the first service computer AP1 or the second service computer AP2 (“pull process”). Alternatively, the presence computer PR waits until one of the service computers AP1 or AP2 or one of the networks N1 or N2 transmits the respective retrieved individual presence data to the presence computer PR (“push process”). The individual presence data can be requested from the presence server or transferred thereto using a wide variety of inherently known interfaces or transfer protocols. These include the protocols CAP, MAP, SIP and Radius.

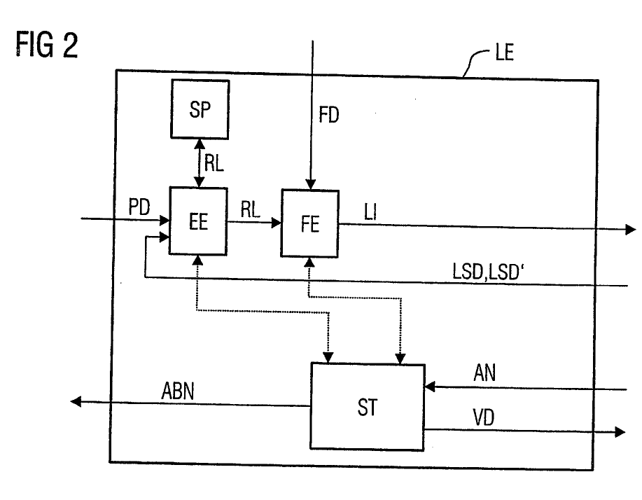

In this way, the presence computer PR receives presence information about a large number of very different further communication terminals, from which the communication terminals KEG2 and KEG3 have been mentioned merely by way of example. From this set of individual presence data, the presence computer PR selects, on the basis of the retrieval message ABN, those presence data which are required by the list generation device LE for the first communication terminal KEG1 and sends these presence data PD to the list generation device LE. The list generation device LE sends the type information item TYP received from the first communication terminal KEG1 to a data store S which stores format data FD describing the data formats which can be shown on the display unit A of the first communication terminal KEG1. The format data FD associated with the first communication terminal KEG1 are read from the data store and are transmitted to the list generation device LE. The format data include, in particular, the information regarding the data format or file format in which the list needs to be sent to the first communication terminal KEG1 (for example in HTML (HyperText Markup Language) format using the http (HyperText Transfer Protocol) protocol, as an XML (eXtensible Markup Language) document, in ASCII format or as a PDF file. Using the format data FD, the list generation device LE generates from the presence data PD a list LI which has a data format which can be shown on the display unit A of the first communication terminal KEG1. Details regarding the generation of this list LI are explained in connection with FIG. 2. The list LI is transferred from the list generation device LE via the switching center VST to the first communication terminal KEG1 and is shown by the latter on the display unit A.

The display unit A of the first communication terminal KEG1 now shows the information that the further communication terminal KEG3 has currently started an online game application on the second service computer AP2 and accordingly communication with the communication terminal KEG3 can be started by taking part in the online game. Similarly, the display A shows that the further communication terminal KEG2 has started an e-mail application on the first service computer AP1 and that accordingly it is possible to communicate with the further communication terminal KEG2 by e-mail. This currently existing opportunity for communication can be displayed on the display unit A by outputting small-format images (icons). By way of example, an envelope representation can be used as such an image, which symbolizes the fact that the communication terminal KEG2 can be reached by e-mail. Similarly, the fact that the communication terminal KEG3 can currently be reached via the online game can be visually displayed by outputting an image which describes the respective online game—for example a schematic representation of four playing pieces for an online strategy game which is currently in progress. By marking or activating the appropriate small-format image on the display A of the first communication terminal KEG1 (for example by positioning a cursor on the appropriate image and by operating a control element, e.g. a key on the first communication terminal), a corresponding computer application (which is a computer program, a communication program, for example) is started on the first communication terminal and can be used to set up a communication link between the first communication terminal KEG1 and the corresponding further communication terminal KEG2 or KEG3. Hence, if the symbol for e-mail communication is selected on the first communication terminal KEG1, then an e-mail client (e-mail program) is started on this first communication terminal KEG1 and a user of the first communication terminal KEG1 can use the e-mail client to set up a communication link to the e-mail program on the second communication terminal KEG2 on the first service computer AP1 directly. It is thus advantageously possible to set up and conduct communication between the first communication terminal KEG1 and the second communication terminal KEG2 in a very convenient manner.

When creating the list LI, the list generation device LE generates charging data VD which relate to the type and scope of the created list LI and allow the communication terminal KEG1 or a user of this first communication terminal to be charged. To create the charging data VD, the list generation device LE ascertains and logs various features which relate to the list creation. In particular, the following may be used to generate the charging data VD:
the number of users, or their further communication terminals (landline telephone, mobile telephone or e-mail client) which are to be monitored and have been determined by selection message AN,
the type of applications used by the further communication terminals (e.g. the programs on the first service computer AP1 or on the second service computer AP2),
the scope of the list, as stipulated by the list structure data,
the type of the first communication terminal KEG1,
the frequency of occurrence of new, updated presence data,
the number of presence information items provided by the presence server per further communication terminal.

From these features cited by way of example, the list generation device LE ascertains a debit sum which is used to charge the communication terminal KEG1 or the user of this communication terminal. In this case, the sum to be transferred with the charging data VD can be ascertained by summing individual charging sums which are associated with each of the aforementioned features.

Alternatively, an all-inclusive sum may also be provided for use of the method for showing presence data, said sum being generated and processed as charging data VD.

In a first refined form of the method, the charging data VD are transmitted from the list generation device LE to the switching center VST in the first communication network KN. The switching center VST then generates charge tickets T associated with the charging data and sends these charge tickets to a charge credit device in the form of a postpaid invoicing device PP. Invoicing devices of this type, as such, are known in mobile telephone networks and are used to create the charge invoices (to be sent on a monthly basis, for example) for the mobile telephone calls made. Following receipt of the charge tickets T, such a charge credit device is used to bill for the service of showing the presence data PD on the display unit A of the first communication terminal KEG1.

In a second refined form, the charging data VD are sent via the switching center VST to the service switching point SSP in the first communication network MFN1, which is in the form of an intelligent network. The service switching point SSP starts a charge billing service on its associated service control point SCP and sends the charging data VD to this service control point SCP. The service control point manages a prepaid account GK associated with the first communication terminal KEG1 and debits the appropriate charge sum from the prepaid account GK. The management and running of prepaid accounts in mobile radio networks per se is known and is called prepaid charge billing.

FIG. 2 gives a more detailed explanation of the method steps taking place in the list generation device LE. The selection message AN already explained with reference to FIG. 1 arrives at a control device ST in the list generation device LE, which uses the information contained in the selection message AN to generate the retrieval message ABN and forwards it to the list generation device LE. The presence computer PR (not shown in FIG. 2) then sends the necessary presence data PD to a creation device EE in the list generation device LE. This creation device EE processes the presence data PD using the list structure data LSD transmitted by the first communication terminal KEG1, selects from the presence data PD the data required for creating the list LI (e.g. the name of a user, communication terminals which are associated with the user and which can currently be reached, location of the user) and uses such data, possibly from a plurality of users, to generate a crude list RL. This crude list RL is stored in a memory SP in the list generation device LE for later use. The crude list RL is then transmitted to a formatting device FE. This formatting device FE receives the formatting data FD already mentioned above from the data store S. The formatting device FE takes the formatting data FD as a basis for formatting the crude list RL such that a list LI is produced which has a data format which can be shown on the display unit A of the first communication terminal KEG1. Finally, this list LI is transferred from the list generation device LE to the first communication terminal KEG1.

If new list structure data LSD' are sent from the first communication terminal KEG1 to the list generation unit LE at a later time, then these data likewise arrive at the creation device EE. The creation device EE reads the respective crude list RL from the data store SP and makes changes to this crude list RL in line with the new structure needs. These changes may require new presence data PD to be requested from the presence computer PR. A crude list RL updated in this manner is then stored in the memory SP again and is transferred to the formatting device FE. The rest of the procedure corresponds to the procedure illustrated above.

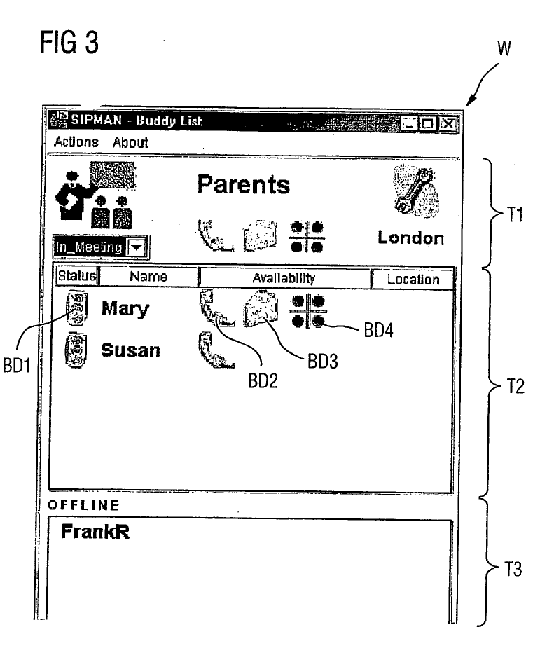

FIG. 3 shows an example of how the list LI can be shown on the display unit A of the first communication terminal KEG1. A display window W shown on the display unit A is divided into three subregions. A first subregion T1 shows data relating to the first communication terminal KEG1: the first communication terminal KEG1 is currently associated with parents, who are currently in a meeting (In_Meeting) in London and with whom it is possible to communicate using a voice telephone link (symbolized by a graphical representation of a telephone receiver), by e-mail (symbolized by a graphical representation of an envelope) and via an online computer game (symbolized by a graphical representation of four playing pieces). A selection list (Drop Down Menu) which currently has the selected entry “In_Meeting” can be used by the parents to change their current whereabouts. The information displayed in the first subregion T1 has been entered by the parents on their first communication terminal KEG1 or has been ascertained automatically by the communication terminal. This information is transmitted from the first communication terminal KEG1 to the presence server PR as individual presence data too (not shown in the figures).

A second subregion T2 and a third subregion T3 show the list LI transferred from the list generation device to the first communication terminal. This list has four columns and two rows in the subregion T2. Each row shows the presence data associated with a further communication terminal. The four columns are used to prescribe the list structure, as transferred from the first communication terminal KEG1 to the list generation device LE using the list structure data LSD described in connection with FIG. 1, for example. The first row of the table shows presence data for a first further communication terminal (similarly to the further communication terminal KEG2 in FIG. 1). This first communication terminal KEG1 can currently be reached (status: symbol image BD1 of a green traffic light) and is used by a user called Mary (a child belonging to the parents) (name: Mary). The user Mary can currently be reached on this communication terminal using a telephone link (availability: graphical symbol BD2 of a telephone receiver), using an e-mail message (availability: image BD3 of an envelope) and using an online computer game (availability: graphical representation BD4 of four playing pieces). The current whereabouts is not known (availability: - ). If the image BD3 on the display unit is activated by positioning a cursor over the image and pressing a key on the mobile telephone, then an e-mail program (e-mail client) is started on the mobile telephone and can be used to generate an e-mail message and to send it to the communication terminal of the user Mary.

The second row of the table uses a graphical representation to indicate that a second communication terminal (similarly to the communication terminal KEG3 in FIG. 1) can currently be reached (status: green traffic light) and is being used by a user Susan. Susan can be reached on this communication terminal by voice telephony (availability: icon symbol of telephone receiver).

The third subregion T3 shows that a further communication terminal, which is associated with a user “FrankR” (=Frank Richter), cannot currently be reached (“offline”).

1. A method for showing a list including presence data on a display unit on a first communication terminal, where the presence data are stored on a presence computer, comprising:
retrieving presence dara via a list generation device using a retrieval message from the presence computer, the presence data relating to a predetermined selection of further communication terminals which are associated with users;
ascertaining format data which are associated with the first communication terminal and which describe a data format which can be shown on the display unit of the first communication terminal;
using the format data to condition the presence data such that a list is produced which has the displayable data format; and
transferring the list to the first communication terminal for display on the display unit.

2. The method as claimed in claim 1, wherein
the format data are ascertained by virtue of the list generation device receiving a type information item from the first communication terminal, and
the type information item is used by the list generation devices to read the format data from a data store.

3. The method as claimed in claim 1, wherein
the list generation device retrieves from the presence computer, as presence data, data which describe an opportunity for communication between the first communication terminal and the further communication terminals at the time of retrieval.

4. The method as claimed in claim 1, wherein
the list is generated using list structure data, describing the structure of the list, which have already been transmitted from the first communication terminal to the list generation device.

5. The method as claimed in claim 1, wherein
the list is stored in the list generation device, and
if further list structure data arrive after the time of storage then the list is adapted in line with these further list structure data.

6. The method as claimed in claim 1, wherein
the list generation device receives a selection message which is transferred from the first communication terminal and which includes information about the predetermined selection of further communication terminals.

7. The method as claimed in claim 6, wherein
the list generation device uses the retrieval message to transfer the information about the predetermined selection of further communication terminals to the presence computer, which then ascertains the presence data about these further communication terminals and transfers them to the list generation device.

8. The method as claimed in claim 7, wherein
the presence computer ascertains the presence data by reading from a memory apparatus.

9. The method as claimed in claim 1, wherein
the list generation device creates charging data which relate to the list which has been transferred to the first communication terminal.

10. The method as claimed in claim 9, wherein
the list generation device transmits the charging data to a first switching center in the first communication network, and
the switching center then generates charge tickets associated with the charging data for the purpose of further processing in a charge credit device.

11. The method as claimed in claim 9, wherein
the list generation device sends the charging data to a service switching point in the first communication network, and
the charging data are then taken as a basis for debiting a charge sum from a prepaid account which is associated with the first communication terminal.

12. The method as claimed in claim 1, wherein
the presence data are shown on the display unit in the form of images associated with the presence data, and
activation of an image starts a communication program on the first communication terminal which allows communication between the first communication terminal and one of the further communication terminals.
